(19) United States
(12) Patent Application Publication
(10) Pub. No.: US 2012/0213141 A1
(43) Pub. Date: Aug. 23, 2012

(54) ENHANCED MULTIMEDIA BROADCAST MULTICAST SERVICE CARRIERS IN CARRIER AGGREGATION

(75) Inventor: JELENA M. DAMNJANOVIC, Del Mar, CA (US)

(73) Assignee: QUALCOMM Incorporated, San Diego, CA (US)

(21) Appl. No.: 13/344,355

(22) Filed: Jan. 5, 2012

Related U.S. Application Data
(60) Provisional application No. 61/445,435, filed on Feb. 22, 2011.

(51) Int. Cl. H04W 4/06; H04H 20/71

(52) U.S. Cl. 370/312

(57) ABSTRACT

In a first configuration, a method, an apparatus, and a computer program product for wireless communication are provided. The apparatus receives a configuration for an extension carrier. In addition, the apparatus receives MBMS information on the extension carrier on at least two subframes of a radio frame. In a second configuration, a method, an apparatus, and a computer program product for wireless communication are provided. The apparatus receives a configuration for a carrier. In addition, the apparatus receives MBMS information on the carrier on at least seven subframes of a radio frame.

### CROSS-REFERENCE TO RELATED APPLICATION(S)

This application claims the benefit of U.S. Provisional Application Ser. No. 61/445,435, entitled “ENHANCED MULTIMEDIA BROADCAST MULTICAST SERVICE CARRIERS IN CARRIER AGGREGATION” and filed on Feb. 22, 2011, which is expressly incorporated by reference herein in its entirety.

### BACKGROUND

1. Field

Aspects of the present disclosure relate generally to wireless communication systems, and more particularly, to enhanced multimedia broadcast multicast service (eMBMS) carriers in carrier aggregation.

2. Background

Wireless communication networks are widely deployed to provide various communication services such as voice, video, packet data, messaging, broadcast, etc. These wireless networks may be multiple-access networks capable of supporting multiple users by sharing the available network resources. Examples of such multiple-access networks include Code Division Multiple Access (CDMA) networks, Time Division Multiple Access (TDMA) networks, Frequency Division Multiple Access (FDMA) networks, Orthogonal FDMA (OFDMA) networks, and Single-Carrier FDMA (SC-FDMA) networks.

A wireless communication network may include a number of base stations that can support communication for a number of user equipments (UEs). A UE may communicate with a base station via the downlink and uplink. The downlink (or forward link) refers to the communication link from the base station to the UE, and the uplink (or reverse link) refers to the communication link from the UE to the base station.

### SUMMARY

In an aspect of the disclosure, a method, a computer program product, and an apparatus are provided. The apparatus receives a configuration for an extension carrier. In addition, the apparatus receives MBMS information on the extension carrier on at least two subframes of a radio frame.

In an aspect of the disclosure, a method, a computer program product, and an apparatus are provided. The apparatus receives a configuration for a carrier. In addition, the apparatus receives MBMS information on the carrier on at least seven subframes of a radio frame.

### BRIEF DESCRIPTION OF THE DRAWINGS

FIG. 1 is a block diagram conceptually illustrating an example of a telecommunications system.

FIG. 2 is a block diagram conceptually illustrating an example of a downlink frame structure in a telecommunications system.

FIG. 3 is a block diagram conceptually illustrating a design of a base station/eNB and a UE configured according to one aspect of the present disclosure.

FIG. 4A discloses a continuous carrier aggregation type.

FIG. 4B discloses a non-continuous carrier aggregation type.

FIG. 5 discloses medium access control (MAC) layer data aggregation.

FIG. 6 is a block diagram illustrating a method for controlling radio links in multiple carrier configurations.

FIG. 7A is a diagram for illustrating a first exemplary method.

FIG. 7B is a diagram illustrating an extension carrier in a downlink band with a paired extension carrier in an uplink band.

FIG. 7C is a diagram illustrating an extension carrier in a downlink band without a corresponding paired extension carrier in an uplink band.

FIG. 8 is a diagram for illustrating a second exemplary method.

FIG. 9 is a flow chart of an exemplary method of wireless communication.

FIG. 10 is a flow chart of another exemplary method of wireless communication.

FIG. 11 is a conceptual data flow diagram illustrating the data flow between different modules/means/components in an exemplary apparatus.

FIG. 12 is a diagram illustrating an example of a hardware implementation for an apparatus employing a processing system.

FIG. 13 is a conceptual data flow diagram illustrating the data flow between different modules/means/components in an exemplary apparatus.

FIG. 14 is a diagram illustrating an example of a hardware implementation for an apparatus employing a processing system.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

The techniques described herein may be used for various wireless communication networks such as CDMA, TDMA, FDMA, OFDMA, SC-FDMA and other networks. The terms “network” and “system” are often used interchangeably. A CDMA network may implement a radio technology such as Universal Terrestrial Radio Access (UTRA), cdma2000, etc. UTRA includes Wideband CDMA (WCDMA) and other variants of CDMA. cdma2000 covers IS-2000, IS-95 and IS-856 standards. A TDMA network may implement a radio technology such as Global System for Mobile Communications (GSM). An OFDMA network may implement a radio technology such as Evolved UTRA (E-UTRA), Ultra Mobile Broadband (UMB), IEEE 802.11 (Wi-Fi), IEEE 802.16 (WiMAX), IEEE 802.20, Flash-OFDMA, etc. UTRA and E-UTRA are part of Universal Mobile Telecommunication System (UMTS). 3GPP Long Term Evolution (LTE) and LTE-Advanced (LTE-A) are new releases of UMTS that use E-UTRA. UTRA, E-UTRA, UMTS, LTE, LTE-A and GSM are described in documents from an organization named “3rd Generation Partnership Project” (3GPP). cdma2000 and UMB are described in documents from an organization named “3rd Generation Partnership Project 2” (3GPP2). The techniques described herein may be used for the wireless networks and radio technologies mentioned above as well as other wireless networks and radio technologies. For clarity, certain aspects of the techniques are described below for LTE, and LTE terminology is used in much of the description below.

Several aspects of telecommunication systems will now be presented with reference to various apparatus and methods. These apparatus and methods will be described in the following detailed description and illustrated in the accompanying drawing by various blocks, modules, components, circuits, steps, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented with a “processing system” that includes one or more processors. Examples of processors include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on a computer-readable medium. The computer-readable medium may be a non-transitory computer-readable medium. A non-transitory computer-readable medium include, by way of example, a magnetic storage device (e.g., hard disk, floppy disk, magnetic strip), an optical disk (e.g., compact disk (CD), digital versatile disk (DVD)), a smart card, a flash memory device (e.g., card, stick, key drive), random access memory (RAM), read only memory (ROM), programmable ROM (PROM), erasable PROM (EPROM), electrically erasable PROM (EEPROM), a register, a removable disk, and any other suitable medium for storing software and/or instructions that may be accessed and read by a computer. The computer-readable medium may be resident in the processing system, external to the processing system, or distributed across multiple entities including the processing system. The computer-readable medium may be embodied in a computer-program product. By way of example, a computer-program product may include a computer-readable medium in packaging materials. Those skilled in the art will recognize how best to implement the described functionality presented throughout this disclosure depending on the particular application and the overall design constraints imposed on the overall system.

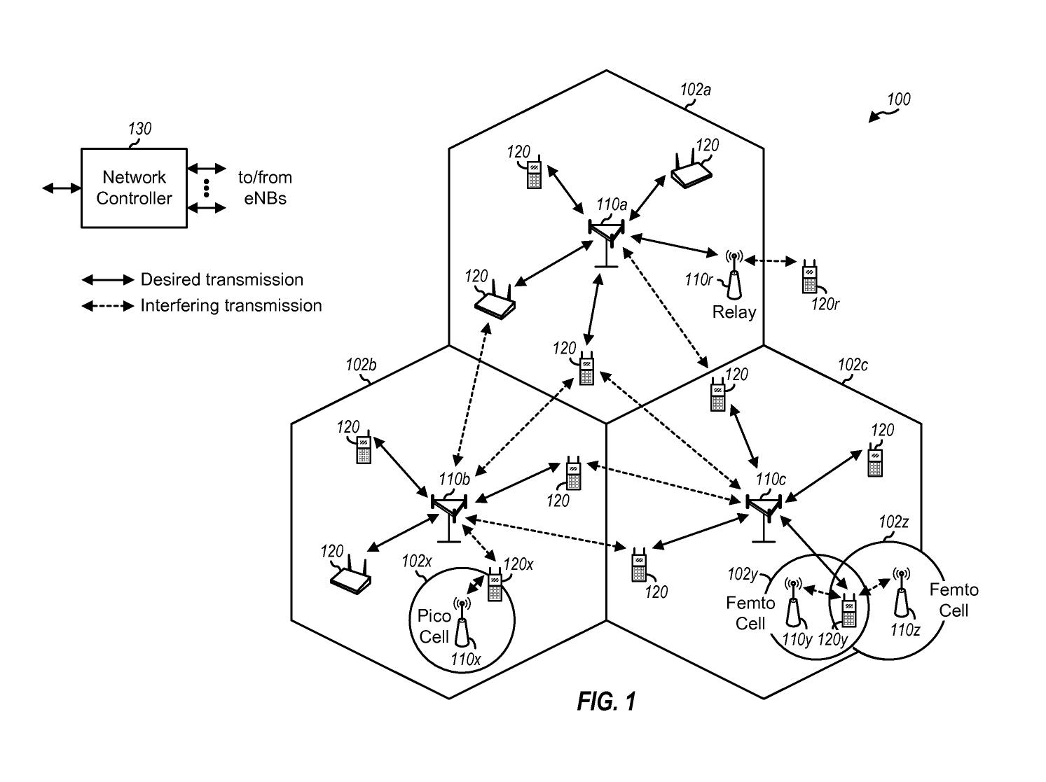

FIG. 1 shows a wireless communication network 100, which may be an LTE network. The wireless network 100 may include a number of evolved Node Bs (eNBs) 110 and other network entities. An eNB may be a station that communicates with the UEs and may also be referred to as a base station, an access point, etc. A Node B is another example of a station that communicates with the UEs.

Each eNB 110 may provide communication coverage for a particular geographic area. In 3GPP, the term “cell” can refer to a coverage area of an eNB and/or an eNB subsystem serving this coverage area, depending on the context in which the term is used.

An eNB may provide communication coverage for a macro cell, a pico cell, a femto cell, and/or other types of cell. A macro cell may cover a relatively large geographic area (e.g., several kilometers in radius) and may allow unrestricted access by UEs with service subscription. A pico cell may cover a relatively small geographic area and may allow unrestricted access by UEs with service subscription. A femto cell may cover a relatively small geographic area (e.g., a home) and may allow restricted access by UEs having association with the femto cell (e.g., UEs in a Closed Subscriber Group (CSG), UEs for users in the home, etc.). An eNB for a macro cell may be referred to as a macro eNB. An eNB for a pico cell may be referred to as a pico eNB. An eNB for a femto cell may be referred to as a femto eNB or a home eNB. In the example shown in FIG. 1, the eNBs 110a, 110b and 110c may be macro eNBs for the macro cells 102a, 102b and 102c, respectively. The eNB 110x may be a pico eNB for a pico cell 102x. The eNBs 110y and 110z may be femto eNBs for the femto cells 102y and 102z, respectively. An eNB may support one or multiple (e.g., three) cells.

The wireless network 100 may also include relay stations. A relay station is a station that receives a transmission of data and/or other information from an upstream station (e.g., an eNB or a UE) and sends a transmission of the data and/or other information to a downstream station (e.g., a UE or an eNB). A relay station may also be a UE that relays transmissions for other UEs. In the example shown in FIG. 1, a relay station 110r may communicate with the eNB 110a and a UE 120r in order to facilitate communication between the eNB 110a and the UE 120r. A relay station may also be referred to as a relay eNB, a relay, etc.

The wireless network 100 may be a heterogeneous network that includes eNBs of different types, e.g., macro eNBs, pico eNBs, femto eNBs, relays, etc. These different types of eNBs may have different transmit power levels, different coverage areas, and different impact on interference in the wireless network 100. For example, macro eNBs may have a high transmit power level (e.g., 20 Watts) whereas pico eNBs, femto eNBs and relays may have a lower transmit power level (e.g., 1 Watt).

The wireless network 100 may support synchronous or asynchronous operation. For synchronous operation, the eNBs may have similar frame timing, and transmissions from different eNBs may be approximately aligned in time. For asynchronous operation, the eNBs may have different frame timing, and transmissions from different eNBs may not be aligned in time. The techniques described herein may be used for both synchronous and asynchronous operation.

A network controller 130 may couple to a set of eNBs and provide coordination and control for these eNBs. The network controller 130 may communicate with the eNBs 110 via a backhaul. The eNBs 110 may also communicate with one another, e.g., directly or indirectly via wireless or wireline backhaul.

The UEs 120 may be dispersed throughout the wireless network 100, and each UE may be stationary or mobile. A UE may also be referred to as a terminal, a mobile station, a subscriber unit, a station, etc. A UE may be a cellular phone, a personal digital assistant (PDA), a wireless modem, a wireless communication device, a handheld device, a laptop computer, a cordless phone, a wireless local loop (WLL) station, etc. A UE may be able to communicate with macro eNBs, pico eNBs, femto eNBs, relays, etc. In FIG. 1, a solid line with double arrows indicates desired transmissions between a UE and a serving eNB, which is an eNB designated to serve the UE on the downlink and/or uplink. A dashed line with double arrows indicates interfering transmissions between a UE and an eNB.

LTE utilizes orthogonal frequency division multiplexing (OFDM) on the downlink and single-carrier frequency division multiplexing (SC-FDM) on the uplink. OFDM and SC-FDM partition the system bandwidth into multiple (K) orthogonal subcarriers, which are also commonly referred to as tones, bins, etc. Each subcarrier may be modulated with data. In general, modulation symbols are sent in the frequency domain with OFDM and in the time domain with SC-FDM. The spacing between adjacent subcarriers may be fixed, and the total number of subcarriers (K) may be dependent on the system bandwidth. For example, the spacing of the subcarriers may be 15 kHz and the minimum resource allocation (called a ‘resource block’) may be 12 subcarriers (or 180 kHz). Consequently, the nominal FFT size may be equal to 128, 256, 512, 1024 or 2048 for system bandwidth of 1.25, 2.5, 5, 10 or 20 megahertz (MHz), respectively. The system bandwidth may also be partitioned into subbands. For example, a subband may cover 1.08 MHz (i.e., 6 resource blocks), and there may be 1, 2, 4, 8 or 16 subbands for system bandwidth of 1.25, 2.5, 5, 10 or 20 MHz, respectively.

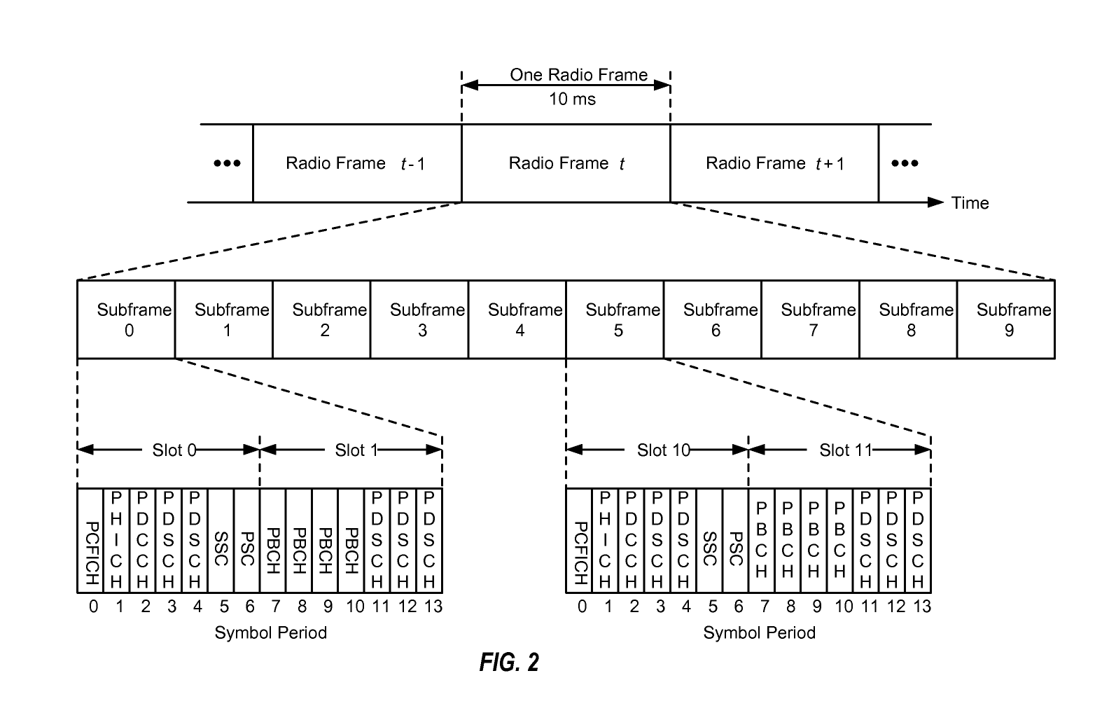

FIG. 2 shows a downlink frame structure used in LTE. The transmission timeline for the downlink may be partitioned into units of radio frames. Each radio frame may have a predetermined duration (e.g., 10 milliseconds (ms)) and may be partitioned into 10 subframes with indices of 0 through 9. Each subframe may include two slots. Each radio frame may thus include 20 slots with indices of 0 through 19. Each slot may include L symbol periods, e.g., 7 symbol periods for a normal cyclic prefix (as shown in FIG. 2) or 6 symbol periods for an extended cyclic prefix. The 2L symbol periods in each subframe may be assigned indices of 0 through 2L-1. The available time frequency resources may be partitioned into resource blocks. Each resource block may cover N subcarriers (e.g., 12 subcarriers) in one slot.

In LTE, an eNB may send a primary synchronization signal (PSS) and a secondary synchronization signal (SSS) for each cell in the eNB. The primary and secondary synchronization signals may be sent in symbol periods 6 and 5, respectively, in each of subframes 0 and 5 of each radio frame with the normal cyclic prefix, as shown in FIG. 2. The synchronization signals may be used by UEs for cell detection and acquisition. The eNB may send a Physical Broadcast Channel (PBCH) in symbol periods 0 to 3 in slot 1 of subframe 0. The PBCH may carry certain system information.

The eNB may send a Physical Control Format Indicator Channel (PCFICH) in only a portion of the first symbol period of each subframe, although depicted in the entire first symbol period in FIG. 2. The PCFICH may convey the number of symbol periods (M) used for control channels, where M may be equal to 1, 2 or 3 and may change from subframe to subframe. M may also be equal to 4 for a small system bandwidth, e.g., with less than 10 resource blocks. In the example shown in FIG. 2, M=3. The eNB may send a Physical HARQ Indicator Channel (PHICH) and a Physical Downlink Control Channel (PDCCH) in the first M symbol periods of each subframe (M=3 in FIG. 2). The PHICH may carry information to support hybrid automatic retransmission (HARM). The PDCCH may carry information on uplink and downlink resource allocation for UEs and power control information for uplink channels. Although not shown in the first symbol period in FIG. 2, it is understood that the PDCCH and PHICH are also included in the first symbol period. Similarly, the PHICH and PDCCH are also both in the second and third symbol periods, although not shown that way in FIG. 2. The eNB may send a Physical Downlink Shared Channel (PDSCH) in the remaining symbol periods of each subframe. The PDSCH may carry data for UEs scheduled for data transmission on the downlink. The various signals and channels in LTE are described in 3GPP TS 36.211, entitled “Evolved Universal Terrestrial Radio Access (E-UTRA); Physical Channels and Modulation,” which is publicly available.

The eNB may send the PSS, SSS and PBCH in the center 1.08 MHz of the system bandwidth used by the eNB. The eNB may send the PCFICH and PHICH across the entire system bandwidth in each symbol period in which these channels are sent. The eNB may send the PDCCH to groups of UEs in certain portions of the system bandwidth. The eNB may send the PDSCH to specific UEs in specific portions of the system bandwidth. The eNB may send the PSS, SSS, PBCH, PCFICH and PHICH in a broadcast manner to all UEs, may send the PDCCH in a unicast manner to specific UEs, and may also send the PDSCH in a unicast manner to specific UEs.

A number of resource elements may be available in each symbol period. Each resource element may cover one subcarrier in one symbol period and may be used to send one modulation symbol, which may be a real or complex value. Resource elements not used for a reference signal in each symbol period may be arranged into resource element groups (REGs). Each REG may include four resource elements in one symbol period. The PCFICH may occupy four REGs, which may be spaced approximately equally across frequency, in symbol period 0. The PHICH may occupy three REGs, which may be spread across frequency, in one or more configurable symbol periods. For example, the three REGs for the PHICH may all belong in symbol period 0 or may be spread in symbol periods 0, 1 and 2. The PDCCH may occupy 9, 18, 32 or 64 REGs, which may be selected from the available REGs, in the first M symbol periods. Only certain combinations of REGs may be allowed for the PDCCH.

A UE may know the specific REGs used for the PHICH and the PCFICH. The UE may search different combinations of REGs for the PDCCH. The number of combinations to search is typically less than the number of allowed combinations for the PDCCH. An eNB may send the PDCCH to the UE in any of the combinations that the UE will search.

A UE may be within the coverage of multiple eNBs. One of these eNBs may be selected to serve the UE. The serving eNB may be selected based on various criteria such as received power, path loss, signal-to-noise ratio (SNR), etc.

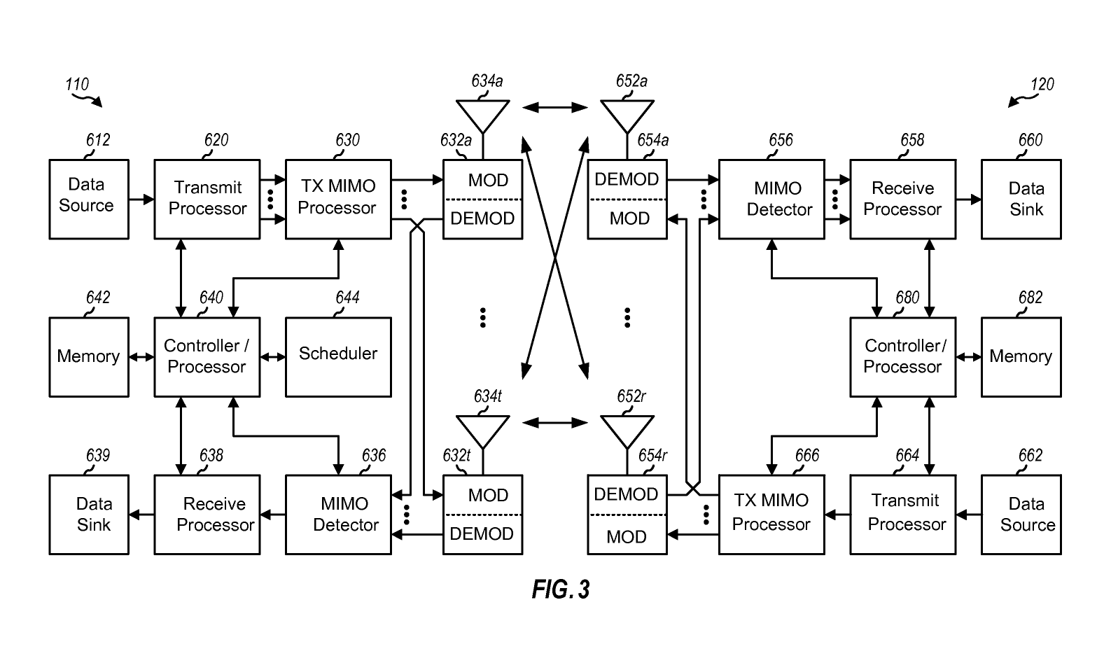

FIG. 3 shows a block diagram of a design of a base station/eNB 110 and a UE 120, which may be one of the base stations/eNBs and one of the UEs in FIG. 1. For a restricted association scenario, the base station 110 may be the macro eNB 110c in FIG. 1, and the UE 120 may be the UE 120y. The base station 110 may also be a base station of some other type. The base station 110 may be equipped with antennas 634a through 634t, and the UE 120 may be equipped with antennas 652a through 652r.

At the base station 110, a transmit processor 620 may receive data from a data source 612 and control information from a controller/processor 640. The control information may be for the PBCH, PCFICH, PHICH, PDCCH, etc. The data may be for the PDSCH, etc. The processor 620 may process (e.g., encode and symbol map) the data and control information to obtain data symbols and control symbols, respectively. The processor 620 may also generate reference symbols, e.g., for the PSS, SSS, and cell-specific reference signal. A transmit (TX) multiple-input multiple-output (MIMO) processor 630 may perform spatial processing (e.g., precoding) on the data symbols, the control symbols, and/or the reference symbols, if applicable, and may provide output symbol streams to the modulators (MODs) 632a through 632t. Each modulator 632 may process a respective output symbol stream (e.g., for OFDM, etc.) to obtain an output sample stream. Each modulator 632 may further process (e.g., convert to analog, amplify, filter, and upconvert) the output sample stream to obtain a downlink signal. Downlink signals from modulators 632a through 632t may be transmitted via the antennas 634a through 634t, respectively.

At the UE 120, the antennas 652a through 652r may receive the downlink signals from the base station 110 and may provide received signals to the demodulators (DEMODs) 654a through 654r, respectively. Each demodulator 654 may condition (e.g., filter, amplify, downconvert, and digitize) a respective received signal to obtain input samples. Each demodulator 654 may further process the input samples (e.g., for OFDM, etc.) to obtain received symbols. A MIMO detector 656 may obtain received symbols from all the demodulators 654a through 654r, perform MIMO detection on the received symbols if applicable, and provide detected symbols. A receive processor 658 may process (e.g., demodulate, deinterleave, and decode) the detected symbols, provide decoded data for the UE 120 to a data sink 660, and provide decoded control information to a controller/processor 680.

On the uplink, at the UE 120, a transmit processor 664 may receive and process data (e.g., for the PUSCH) from a data source 662 and control information (e.g., for the PUCCH) from the controller/processor 680. The processor 664 may also generate reference symbols for a reference signal. The symbols from the transmit processor 664 may be precoded by a TX MIMO processor 666 if applicable, further processed by the modulators 654a through 654r (e.g., for SC-FDM, etc.), and transmitted to the base station 110. At the base station 110, the uplink signals from the UE 120 may be received by the antennas 634, processed by the demodulators 632, detected by a MIMO detector 636 if applicable, and further processed by a receive processor 638 to obtain decoded data and control information sent by the UE 120. The processor 638 may provide the decoded data to a data sink 639 and the decoded control information to the controller/processor 640.

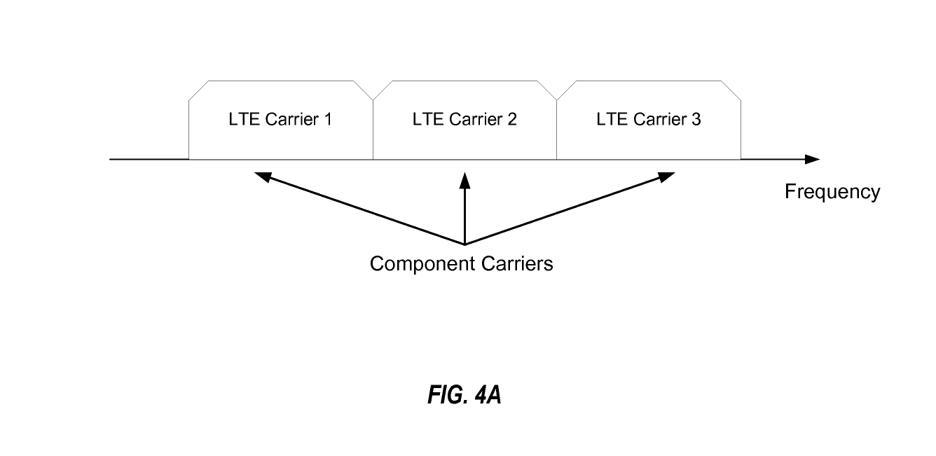

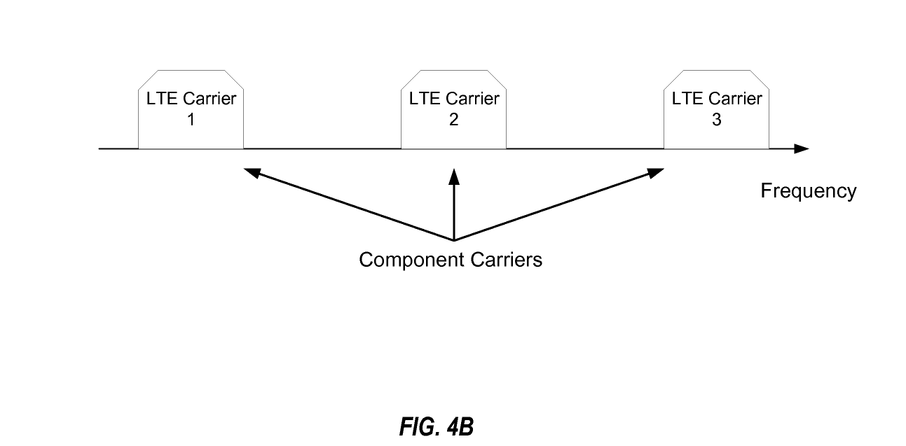

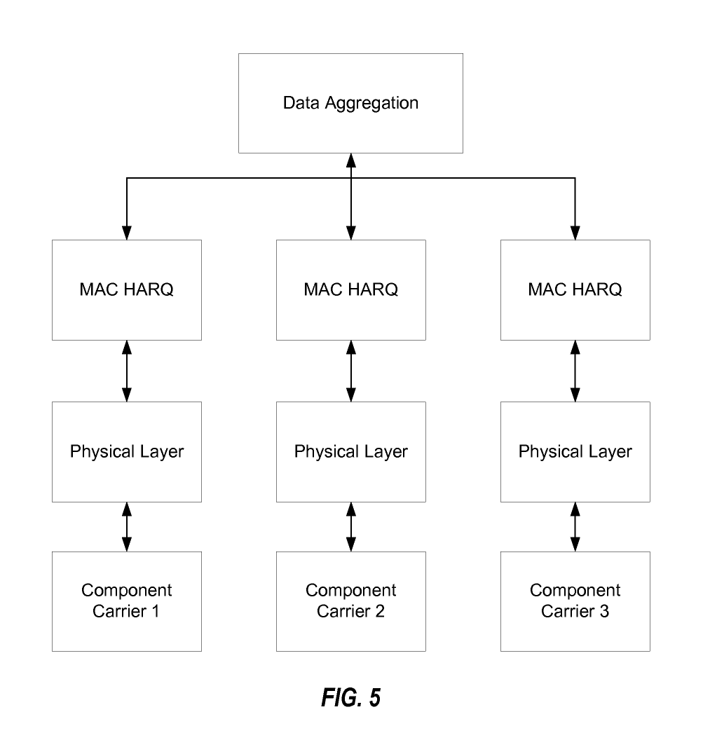

The controllers/processors 640 and 680 may direct the operation at the base station 110 and the UE 120, respectively. The processor 640 and/or other processors and modules at the base station 110 may perform or direct the execution of various processes for the techniques described herein. The processor 680 and/or other processors and modules at the UE 120 may also perform or direct the execution of the functional blocks illustrated in FIGS. 4 and 5, and/or other processes for the techniques described herein. The memories 642 and 682 may store data and program codes for the base station 110 and the UE 120, respectively. A scheduler 644 may schedule UEs for data transmission on the downlink and/or uplink.

In one configuration, the UE 120 for wireless communication includes means for detecting interference from an interfering base station during a connection mode of the UE, means for selecting a yielded resource of the interfering base station, means for obtaining an error rate of a physical downlink control channel on the yielded resource, and means, executable in response to the error rate exceeding a predetermined level, for declaring a radio link failure. In one aspect, the aforementioned means may be the processor(s), the controller/processor 680, the memory 682, the receive processor 658, the MIMO detector 656, the demodulators 654a, and the antennas 652a configured to perform the functions recited by the aforementioned means. In another aspect, the aforementioned means may be a module or any apparatus configured to perform the functions recited by the aforementioned means.

### Carrier Aggregation

LTE-Advanced UEs use spectrum up to 20 Mhz bandwidths allocated in a carrier aggregation of up to a total of 100 Mhz (5 component carriers) used for transmission in each direction. Generally, less traffic is transmitted on the uplink than the downlink, so the uplink spectrum allocation may be smaller than the downlink allocation. For example, if 20 Mhz is assigned to the uplink, the downlink may be assigned 100 Mhz. These asymmetric FDD assignments will conserve spectrum and are a good fit for the typically asymmetric bandwidth utilization by broadband subscribers.

### Carrier Aggregation Types

For the LTE-Advanced mobile systems, two types of carrier aggregation (CA) methods have been proposed, continuous CA and non-continuous CA. They are illustrated in FIGS. 4A and 4B. Non-continuous CA occurs when multiple available component carriers are separated along the frequency band (FIG. 4B). On the other hand, continuous CA occurs when multiple available component carriers are adjacent to each other (FIG. 4A). Both non-continuous and continuous CA aggregate multiple LTE/component carriers to serve a single unit of LTE Advanced UE.

Multiple RF receiving units and multiple FFTs may be deployed with non-continuous CA in LTE-Advanced UE since the carriers are separated along the frequency band. Because non-continuous CA supports data transmissions over multiple separated carriers across a large frequency range, propagation path loss, Doppler shift and other radio channel characteristics may vary a lot at different frequency bands.

Thus, to support broadband data transmission under the non-continuous CA approach, methods may be used to adaptively adjust coding, modulation and transmission power for different component carriers. For example, in an LTE-Advanced system where the eNB has fixed transmitting power on each component carrier, the effective coverage or supportable modulation and coding of each component carrier may be different.

### Data Aggregation Schemes

FIG. 5 illustrates aggregating transmission blocks (TBs) from different component carriers at the medium access control (MAC) layer for an International Mobile Telecommunication (IMT) Advanced system. With MAC layer data aggregation, each component carrier has its own independent hybrid automatic repeat request (HARQ) entity in the MAC layer and its own transmission configuration parameters (e.g., transmitting power, modulation and coding schemes, and multiple antenna configuration) in the physical layer. Similarly, in the physical layer, one HARQ entity is provided for each component carrier.

### Control Signaling

In general, there are three different approaches for deploying control channel signaling for multiple component carriers. The first involves a minor modification of the control structure in LTE systems where each component carrier is given its own coded control channel.

The second method involves jointly coding the control channels of different component carriers and deploying the control channels in a dedicated component carrier. The control information for the multiple component carriers will be integrated as the signaling content in this dedicated control channel. As a result, backward compatibility with the control channel structure in LTE systems is maintained, while signaling overhead in the CA is reduced.

Multiple control channels for different component carriers are jointly coded and then transmitted over the entire frequency band formed by a third CA method. This approach offers low signaling overhead and high decoding performance in control channels, at the expense of high power consumption at the UE side. However, this method is not compatible with LTE systems.

### Handover Control

It is preferable to support transmission continuity during the handover procedure across multiple cells when CA is used for IMT-Advanced UE. However, reserving sufficient system resources (i.e., component carriers with good transmission quality) for the incoming UE with specific CA configurations and quality of service (QoS) requirements may be challenging for the next eNB. The reason is that the channel conditions of two (or more) adjacent cells (eNBs) may be different for the specific UE. In one approach, the UE measures the performance of only one component carrier in each adjacent cell. This offers similar measurement delay, complexity, and energy consumption as that in LTE systems. An estimate of the performance of the other component carriers in the corresponding cell may be based on the measurement result of the one component carrier. Based on this estimate, the handover decision and transmission configuration may be determined.

According to various embodiments, the UE operating in a multicarrier system (also referred to as carrier aggregation) is configured to aggregate certain functions of multiple carriers, such as control and feedback functions, on the same carrier, which may be referred to as a “primary carrier.” The remaining carriers that depend on the primary carrier for support are referred to as associated secondary carriers. For example, the UE may aggregate control functions such as those provided by the optional dedicated channel (DCH), the nonscheduled grants, a physical uplink control channel (PUCCH), and/or a physical downlink control channel (PDCCH). Signaling and payload may be transmitted both on the downlink by the eNode B to the UE, and on the uplink by the UE to the eNode B.

In some embodiments, there may be multiple primary carriers. In addition, secondary carriers may be added or removed without affecting the basic operation of the UE, including physical channel establishment and radio link failure (RLF) procedures which are layer 2 procedures, such as in the 3GPP technical specification 36.331 for the LTE Radio Resource Control (RRC) protocol.

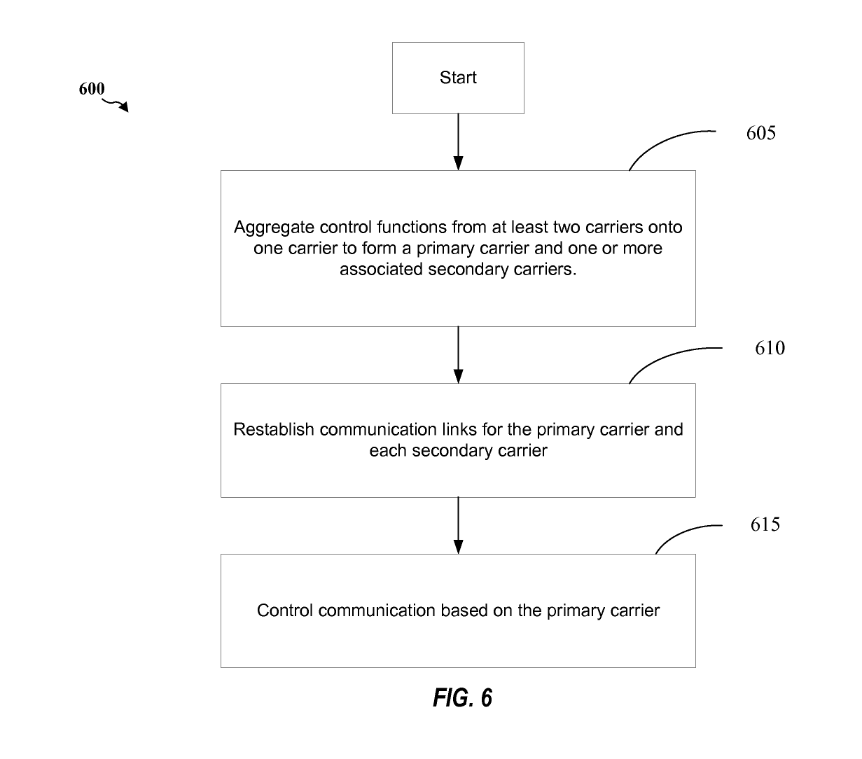

FIG. 6 illustrates a method 600 for controlling radio links in a multiple carrier wireless communication system by grouping physical channels according to one example. As shown, the method includes, at block 605, aggregating control functions from at least two carriers onto one carrier to form a primary carrier and one or more associated secondary carriers. Next at block, 610, communication links are established for the primary carrier and each secondary carrier. Then, communication is controlled based on the primary carrier in block 615.

In LTE Rel-8/9/10, the multimedia broadcast single frequency network (MBSFN) mode of operation is provided only on a frequency layer shared with non MBMS services. As such, cells support both unicast and MBMS transmissions and therefore the cells are MBMS/unicast mixed. In an exemplary configuration, a carrier may provide only broadcast services without unicast services and therefore is an eMBMS carrier only. In another exemplary configuration, a carrier may dedicate more resources to MBMS transmissions than is available in LTE Rel-8/9/10.

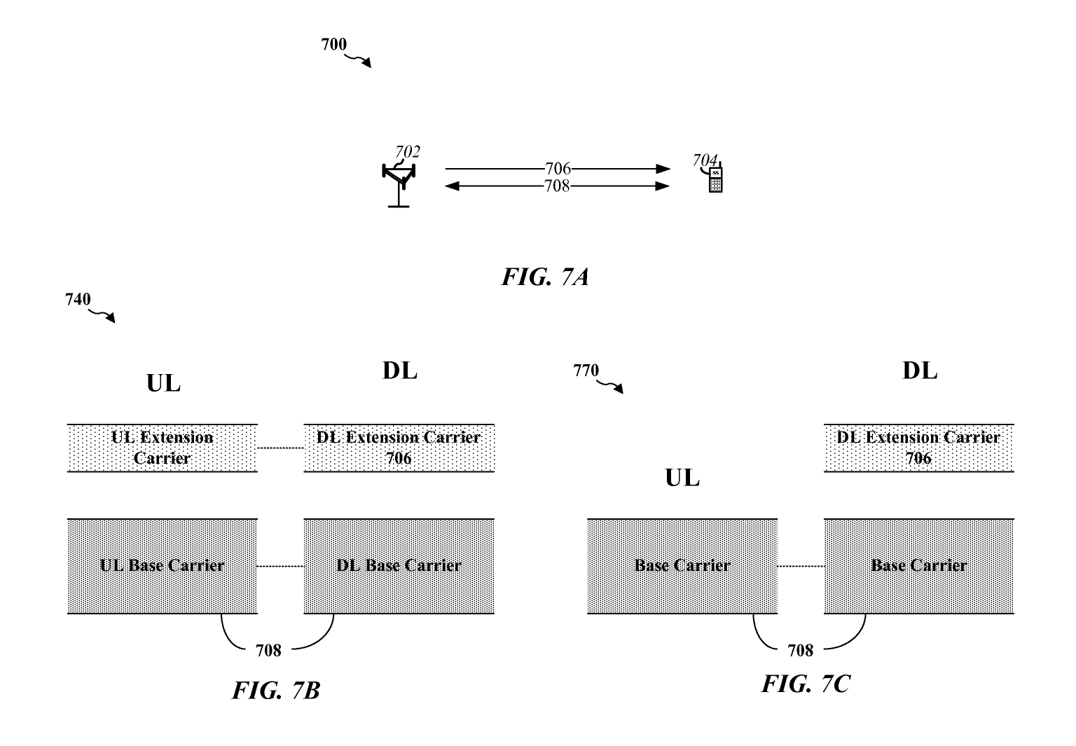

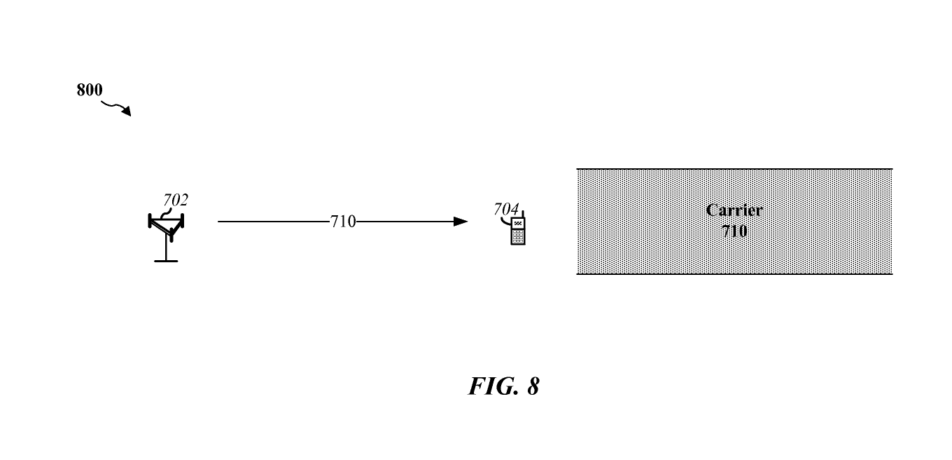

FIG. 7A is a diagram 700 for illustrating a first exemplary method. FIG. 7B is a diagram 740 illustrating an extension carrier in a downlink (DL) band with a paired extension carrier in an uplink (UL) band. FIG. 7C is a diagram 770 illustrating an extension carrier in a DL band without a corresponding paired extension carrier in an UL band. As shown in FIG. 7A, the eNB 702 is in communication with a UE 704 through an extension component carrier (CC) 706 and a primary/base CC 708. The extension CC 706 is a non-self standing carrier that carries eMBMS information. The eMBMS includes MBSFN services. The extension CC 706 is non-self standing because the UE 704 must be configured for the primary CC 708 (i.e., idle or connected) in order to be configured for the extension CC 706. That is, in this configuration, the UE 704 cannot be configured for the extension CC 706 alone. As such, the extension CC 706 can only exist as the part of aggregated CCs, as the extension CC 706 is aggregated with the primary CC 708.

The extension CC 706 provides eMBMS information in at least two subframes of each radio frame. In one configuration, the extension CC 706 provides eMBMS information in at least seven subframes of each radio frame. In contrast, in LTE Rel-8/9, subframes 0, 4, 5, 9 are reserved for a primary synchronization signal (PSS), a secondary synchronization signal (SSS), a physical broadcast channel (PBCH), paging information, system information (SI), and unicast service, and therefore only up to six subframes (i.e., subframes 1-3 and 6-8) in LTE Rel-8/9 may be used to provide broadcast services. A radio frame may contain any number of subframes. In one configuration, a radio frame includes ten subframes. However, a radio frame may include a different number of subframes. As the extension CC 706 in FIG. 7A is identified as a non-self standing carrier, the extension CC 706 does not carry all of the synchronization information, paging information, and SI for itself. In this configuration, the primary CC 708 carries at least one of synchronization information (PSS, SSS), paging information, and SI for the extension CC 706. Generally, in this configuration, the primary CC 708 carries all of the synchronization information, paging information, and SI for the extension CC 706. As such, the UE 704 acquires all SI, paging information, and synchronization information from the primary CC 708. The extension CC 706 may apply the LTE Rel-8/9 eMBMS structure on each of the at least seven subframes. In one configuration, the at least seven subframes includes all subframes (e.g., ten subframes) in a radio frame and therefore the extension CC 706 is used only for broadcast services and is not used for unicast services. When all subframes in a radio frame are used for broadcast services, as shown in FIG. 7C, the extension CC 706 may be in a DL band only (i.e., not in an UL band), and the DL band may not have a corresponding paired UL band. When at least one of the subframes in a radio frame are used for unicast services, as shown in FIG. 7B, the extension CC 706 may be in a DL band that has a corresponding paired UL band. The LTE Rel-8/9 concept that MBMS reception is possible for UEs in RRC connected (RRC_CONNECTED) and RRC idle (RRC_IDLE) states is preserved. Whenever receiving MBMS services, a UE may be notified of an incoming call, and originating calls may be possible.

The UE 704 acquires SI of the extension CC 706. The SI may be acquired through dedicated signaling or common signaling. With dedicated signaling, the cross-carrier SI may be acquired by the UE 704 through notifying the eNB 702 about an interest in MBSFN services and then receiving the SI from the eNB 702 in response. With common signaling, the SI of the extension CC 706 is conveyed by the eNB 702 along with the SI for the primary CC 708. This is equivalent to SI block (SIB) 13 in which MBSFN information of the extension CC 706 is conveyed in the SIB-13. As such, SI of the extension CC 706 may be conveyed by broadcasting the SIB-13. The UE 704 may read the SIB-13 only if interested in broadcast services. In the common signaling configuration, the UE 704 need not notify the eNB 702 of an interest in broadcast services.

FIG. 8 is a diagram 800 for illustrating a second exemplary method. As shown in FIG.

8, the eNB 702 is in communication with a UE 704 through a CC 710. The CC 710 is a self standing carrier that carries eMBMS information. The CC 710 is self standing because the UE 704 may be configured for the CC 710 without being configured and aggregated with a primary CC. That is, in this configuration, the UE 704 can be configured for the CC 710 alone without relying on a base or primary CC to receive SI, paging information, and synchronization information for the CC 710. As such, the CC 710 need not exist as part of the aggregated CCs. In this configuration, the UE 704 receives at least one of SI, paging information, or synchronization information on the CC 710. In this configuration, subframes 0 and 5 may be used for the PDSCH, PBCH, and PSS/SSS. Paging may also be performed in subframes 0 and 5. As such, in this configuration, subframes 1-4 and 6-9 may be used for broadcast services while subframes 0 and 5 may be used for unicast services (for backward compatibility) or mixed unicast and eMBMS. Mixed unicast and eMBMS refers to subframes that carry both unicast and eMBMS information. Using subframes 0 and 5 for mixed unicast and eMBMS is not backwards compatible and requires redesign of the current channel structures. In this configuration, the UE 704 receives from the eNB 702 unicast information or mixed unicast and MBMS information on a subset of subframes of the radio frame. The subset of subframes may be less than four subframes. For example, the subset of subframes may include subframes 0 and 5, subframes 0, 4, and 5, or subframes 0, 5, and 9. With less than four subframes utilized for unicast or mixed unicast and MBMS, more than 60% of the subframes may be utilized for eMBMS. When only subframes 0 and 5 are utilized for unicast and mixed unicast/broadcast services, 80% of subframes are utilized for eMBMS.

Generally, for the non-self standing eMBMS carrier configuration, all LTE Rel-8/9/10 structure and functionality can be utilized. An extension of the SI on the primary CC to include SIB-13 of the eMBMS carrier(s) may be needed if common signaling is used to provide a UE with information on the eMBMS carrier(s). All of the subframes on the eMBMS CC may be utilized for eMBMS. Because the eMBMS CC can exist only as the part of carrier aggregation, UEs not interested in unicast services would still effectively be operating occasionally on a bandwidth of the primary CC. That is, if a UE is not interested in unicast services, the UE would essentially be idle on the primary CC, except for receiving synchronization information, paging information, and SI. The capability of a UE may allow the UE to remain idle on the primary CC, otherwise disruptions in receiving eMBMS may occur.

Generally, for the self-standing eMBMS carrier configuration, all LTE Rel-8/9/10 structure and functionality can be utilized as long as subframes 0 and 5 are used for unicast. If subframes 0 and 5 are used for unicast, 80% of subframes on the eMBMS carrier can be utilized for eMBMS. Paging may be limited to the subframes 0 and 5 rather than the subframes 0, 4, 5, and 9 as in LTE Rel-8/9. UEs not interested in unicast services would be operating on a bandwidth of eMBMS CC(s) only. Which approach is chosen depends on the objectives. A non-self standing eMBMS carrier configuration provides for 100% eMBMS subframe availability, but the eMBMS carrier is dependent on a primary CC. A self-standing eMBMS carrier configuration allows for the eMBMS carrier to be independent of a primary CC, but only provides for 80% eMBMS subframe availability.

The multicast designated carrier may be in a DL designated band only (see FIG. 7C). In such a configuration, there would be no defined corresponding UL carrier. UEs would not be able to camp (i.e., be idle) on such carrier. LTE Rel-8/9 mechanisms to repel UEs from camping are available. For example, cell barring with the intra-frequency cell reselection indication “not allowed.” Such carrier cannot be a primary CC. To make such carrier usable as a primary CC, UE-specific UL-DL linking is needed. LTE Rel-10 currently supports only SIB-2 linking The multicast designated carrier may be in a DL-UL paired band (see FIG. 7B). Existence of some unicast traffic would justify the role of the primary CC. An additional feature for UE-specific UL-DL linking is not necessary.

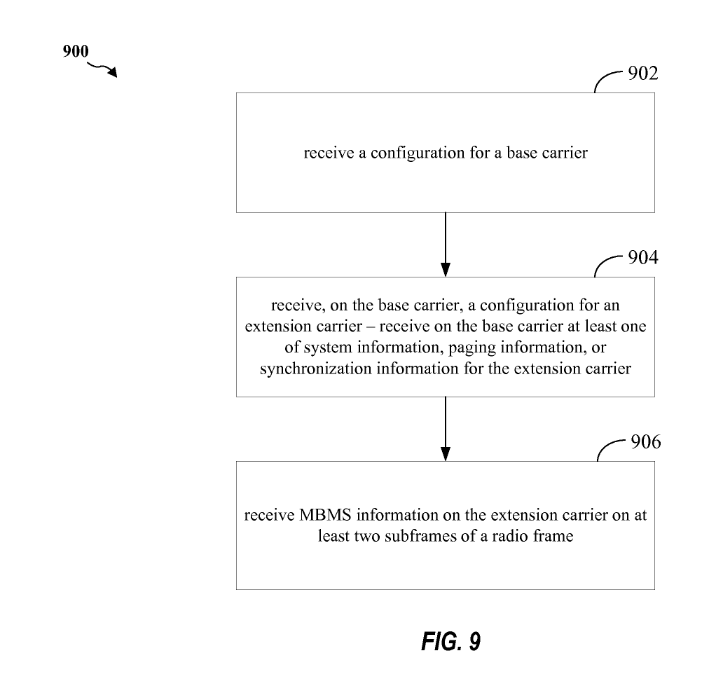

FIG. 9 is a flow chart 900 of an exemplary method of wireless communication. The method may be performed by a UE, such as the UE 120/704. As shown in FIG. 9, in step 902, the UE receives a configuration for a base carrier. In step 904, the UE receives, on the base carrier, a configuration for an extension carrier. The configuration may include system information and/or synchronization information. The UE may also receive paging information for the extension carrier on the base carrier. In step 906, the UE receives MBMS information on the extension carrier in at least two subframes of a radio frame. For example, referring to FIGS. 7A, 7B, 7C, the UE 704 may receive a configuration for the base carrier 708. On the base carrier 708, the UE 704 may receive configuration information for the extension carrier 706. On the extension carrier 706, the UE 704 may receive MBMS information.

An extension carrier is a non-self standing carrier that cannot exist on its own. The extension carrier must be configured as a part of carrier aggregation. As such, a UE must be configured with a base carrier and then can be configured with one or more extension carriers. According to the method, the UE receives MBMS information on the extension carrier on at least two subframes of a radio frame. In one configuration, the MBMS information on the extension carrier may be received in at least seven subframes of the radio frame. As discussed supra, the UE receives a configuration for a base carrier before receiving the configuration for the extension carrier. By definition, the configuration for the extension carrier may only occur while configured for the base carrier. In one configuration, the MBMS information on the extension carrier is received in all subframes of the radio frame, and therefore the extension carrier is an eMBMS carrier only. A UE may receive at least one of SI, paging information, or synchronization information for the extension carrier only on the base carrier. When a UE acquires SI of the extension carrier through dedicated signaling, the UE sends a request to a base station for SI for the extension carrier regarding MBMS provided by the base station on the extension carrier, and receives on the base carrier the SI for the extension carrier regarding MBMS provided by the base station on the extension carrier. When a UE acquires SI of the extension carrier through common signaling, the UE receives from a base station SI for the extension carrier regarding MBMS provided by the base station on the extension carrier. The SI for the extension carrier is broadcast with SI for the base carrier. The UE may receive unicast information or mixed unicast and MBMS information on a subset of subframes of the radio frame. The subset of subframes may include subframe 0 and subframe 5. The radio frame may include ten subframes. In one configuration, the extension carrier is in a DL band only and the DL band does not have a corresponding UL band. In one configuration, the extension carrier is in a DL band that has a corresponding paired UL band.

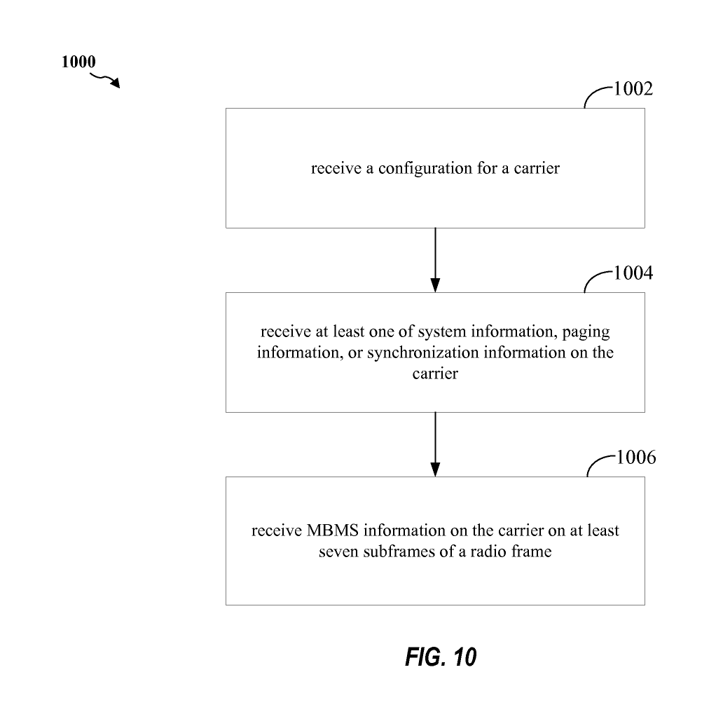

FIG. 10 is a flow chart 1000 of an exemplary method of wireless communication. The method may be performed by a UE, such as the UE 120/704. As shown in FIG. 10, in step 1002, a UE may receive a configuration for a carrier. In step 1004, the UE may receive at least one of SI, paging information, or synchronization information on the carrier. In step 1006, the UE may receive MBMS information on the carrier on at least seven subframes of a radio frame. For example, referring to FIG. 8, the UE 704 may receive a configuration for a carrier 710. The UE 704 may receive at least one of SI, paging information, or synchronization information on the carrier 710. The UE 704 may receive MBMS information on the carrier 710 on at least seven subframes of a radio frame.

The wireless device may be configured only with the carrier and no other carriers. The UE may receive unicast information or mixed unicast and MBMS information only on a subset of subframes of the radio frame, and receive MBMS information on a remaining subset of subframes of the radio frame. The radio frame may include ten subframes. The subset of subframes may include subframe 0 and subframe 5. The remaining subset of subframes may include at least seven subframes of the subframes 1-4 and 6-9.

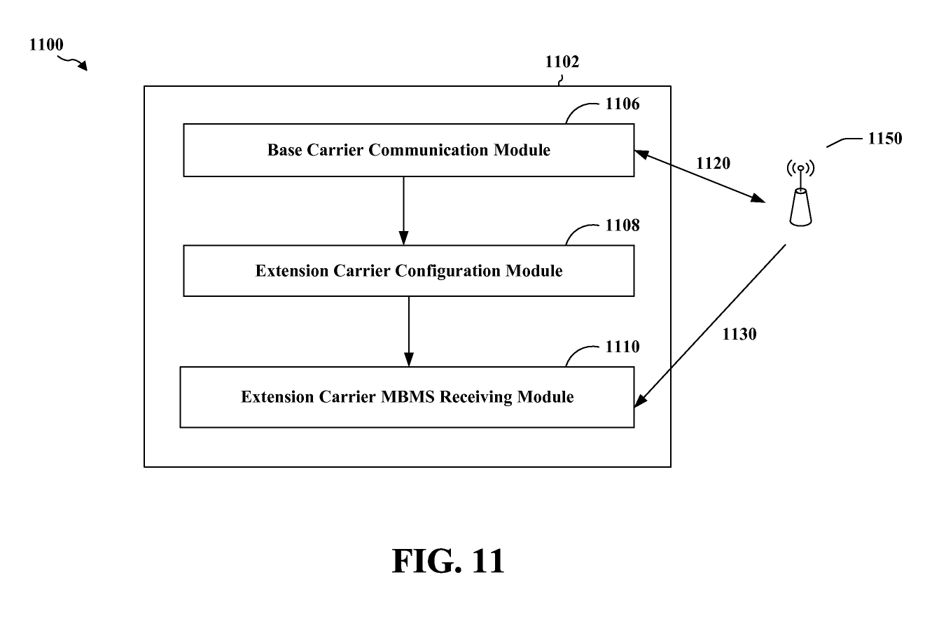

FIG. 11 is a conceptual data flow diagram 1100 illustrating the data flow between different modules/means/components in an exemplary apparatus 1102. The apparatus 1102 may be a UE. The apparatus may include a base carrier communication module 1106, an extension carrier configuration module 1108, and an extension carrier MBMS receiving module 1110. The base carrier communication module 1106 may be configured to communicate 1120 with the eNB 1150 to receive a configuration for a base carrier. The base carrier communication module 1106 may be further configured to communicate 1120 with the eNB 1150 through the base carrier to receive configuration information for an extension carrier. The configuration information may include SI, paging information, and/or synchronization information. In a first configuration, the base carrier communication module 1106 may be configured to receive from the eNB 1150 SI for the extension carrier regarding MBMS provided by the eNB 1150 on the extension carrier. The SI for the extension carrier may be broadcast with SI for the base carrier. In a second configuration, the base carrier communication module 1106 may be configured to send a request to the eNB 1150 for SI for the extension carrier regarding MBMS provided by the eNB 1150 on the extension carrier. The base carrier communication module 1106 may be further configured to receive on the base carrier the SI for the extension carrier regarding MBMS provided by the eNB 1150 on the extension carrier. The base carrier communication module 1106 may be further configured to provide the extension carrier configuration information to the extension carrier configuration module 1108, which provides the extension carrier configuration information to the extension carrier MBMS receiving module 1110. The extension carrier MBMS receiving module 1110 may be configured to receive 1130 MBMS information on the extension carrier on at least two subframes of a radio frame. The extension carrier MBMS receiving module 1110 may be configured to receive MBMS information on the extension carrier on at least seven subframes (e.g., all subframes) of the radio frame. In one configuration, the extension carrier may be a DL band only and the DL band may not have a corresponding UL band. In another configuration, the extension carrier may be in a DL band that has a corresponding paired UL band.

The apparatus may include additional modules that perform each of the steps of the algorithm in the aforementioned flow chart of FIG. 9. As such, each step in the aforementioned flow chart of FIG. 9 may be performed by a module and the apparatus may include one or more of those modules. The modules may be one or more hardware components specifically configured to carry out the stated processes/algorithm, implemented by a processor configured to perform the stated processes/algorithm, stored within a computer-readable medium for implementation by a processor, or some combination thereof

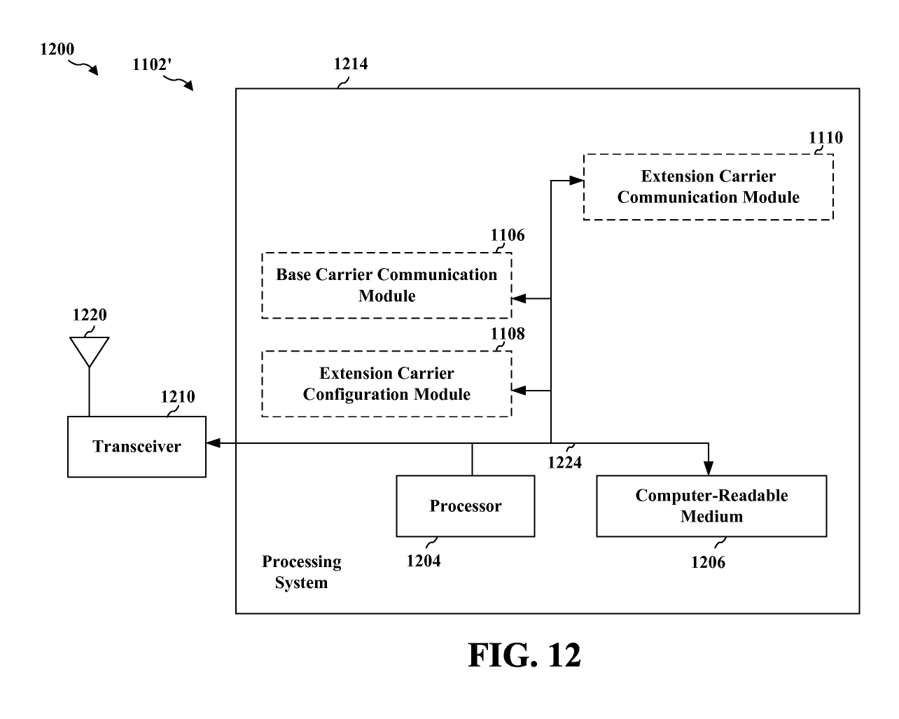

FIG. 12 is a diagram 1200 illustrating an example of a hardware implementation for an apparatus 1102′ employing a processing system 1214. The processing system 1214 may be implemented with a bus architecture, represented generally by the bus 1224. The bus 1224 may include any number of interconnecting buses and bridges depending on the specific application of the processing system 1214 and the overall design constraints. The bus 1224 links together various circuits including one or more processors and/or hardware modules, represented by the processor 1204, the modules 1106, 1108, 1110, and the computer-readable medium 1206. The bus 1224 may also link various other circuits such as timing sources, peripherals, voltage regulators, and power management circuits, which are well known in the art, and therefore, will not be described any further.

The processing system 1214 may be coupled to a transceiver 1210. The transceiver 1210 is coupled to one or more antennas 1220. The transceiver 1210 provides a means for communicating with various other apparatus over a transmission medium. The processing system 1214 includes a processor 1204 coupled to a computer-readable medium 1206. The processor 1204 is responsible for general processing, including the execution of software stored on the computer-readable medium 1206. The software, when executed by the processor 1204, causes the processing system 1214 to perform the various functions described supra for any particular apparatus. The computer-readable medium 1206 may also be used for storing data that is manipulated by the processor 1204 when executing software. The processing system further includes at least one of the modules 1106, 1108, 1110. The modules may be software modules running in the processor 1204, resident/stored in the computer readable medium 1206, one or more hardware modules coupled to the processor 1204, or some combination thereof. The processing system 1214 may be a component of the UE 120 and may include the memory 682 and/or at least one of the TX Processor 664, the RX Processor 658, and the controller/processor 680.

In one configuration, the apparatus 1102/1102′ for wireless communication includes means for receiving a configuration for an extension carrier, and means for receiving MBMS information on the extension carrier on at least two subframes of a radio frame. The apparatus may further include means for receiving a configuration for a base carrier before receiving the configuration for the extension carrier. The apparatus may further include means for receiving at least one of SI, paging information, or synchronization information for the extension carrier only on the base carrier. The apparatus may further include means for sending a request to a base station for SI for the extension carrier regarding MBMS provided by the base station on the extension carrier, and means for receiving on the base carrier the SI for the extension carrier regarding MBMS provided by the base station on the extension carrier. The apparatus may further include means for receiving from a base station SI for the extension carrier regarding MBMS provided by the base station on the extension carrier. In such a configuration the SI for the extension carrier is broadcast with SI for the base carrier. The apparatus may further include means for receiving unicast information or mixed unicast and MBMS information on a subset of subframes of the radio frame. The aforementioned means may be one or more of the aforementioned modules of the apparatus 1102 and/or the processing system 1214 of the apparatus 1102′ configured to perform the functions recited by the aforementioned means. As described supra, the processing system 1214 may include the TX Processor 664, the RX Processor 658, and the controller/processor 680. As such, in one configuration, the aforementioned means may be the TX Processor 664, the RX Processor 658, and the controller/processor 680 configured to perform the functions recited by the aforementioned means.

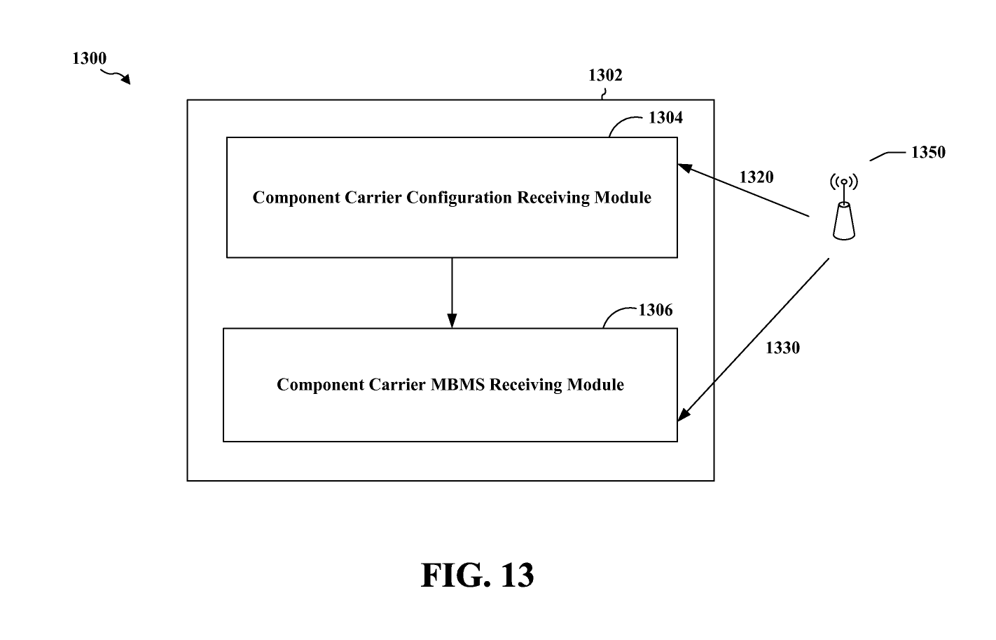

FIG. 13 is a conceptual data flow diagram 1300 illustrating the data flow between different modules/means/components in an exemplary apparatus 1302. The apparatus 1302 may include a component carrier configuration receiving module 1304 and a component carrier MBMS receiving module 1306. The component carrier configuration receiving module 1304 may be configured to receive configuration information 1320 for a carrier from the eNB 1350. The configuration information may include SI, paging information, and/or synchronization information. The component carrier configuration receiving module 1304 may be configured to provide the component carrier configuration information to the component carrier MBMS receiving module 1306. The component carrier MBMS receiving module 1306 may be configured to receive MBMS information 1330 on the carrier on at least seven sub frames of a radio frame.

The apparatus may include additional modules that perform each of the steps of the algorithm in the aforementioned flow chart of FIG. 10. As such, each step in the aforementioned flow chart of FIG. 10 may be performed by a module and the apparatus may include one or more of those modules. The modules may be one or more hardware components specifically configured to carry out the stated processes/algorithm, implemented by a processor configured to perform the stated processes/algorithm, stored within a computer-readable medium for implementation by a processor, or some combination thereof

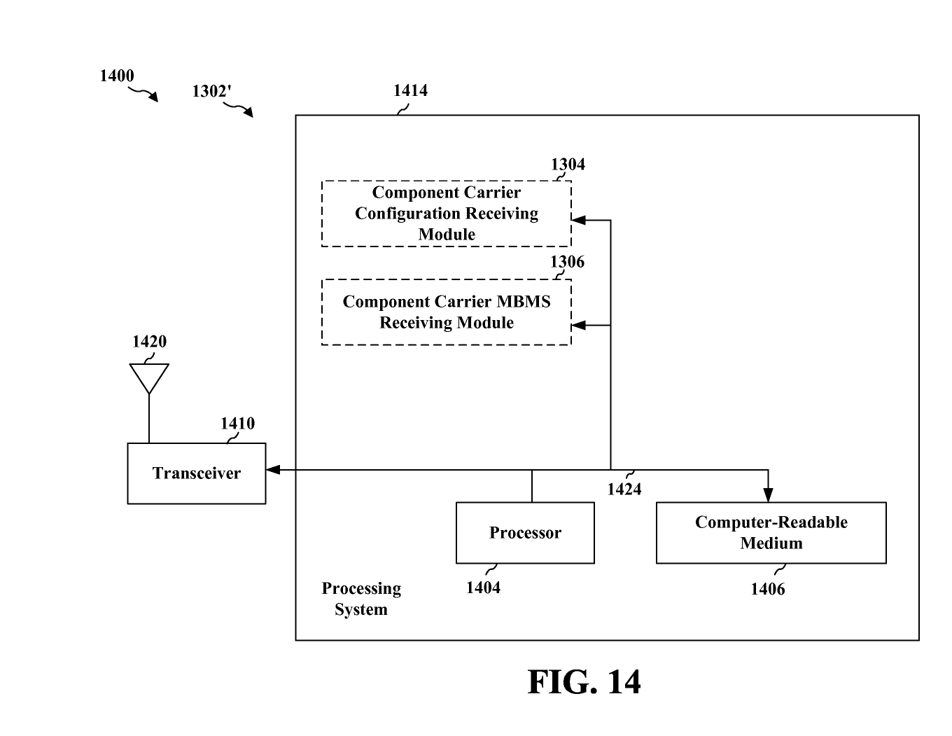

FIG. 14 is a diagram 1400 illustrating an example of a hardware implementation for an apparatus 1302′ employing a processing system. The processing system 1414 may be implemented with a bus architecture, represented generally by the bus 1424. The bus 1424 may include any number of interconnecting buses and bridges depending on the specific application of the processing system 1414 and the overall design constraints. The bus 1424 links together various circuits including one or more processors and/or hardware modules, represented by the processor 1404, the modules 1304, 1306 and the computer-readable medium 1406. The bus 1424 may also link various other circuits such as timing sources, peripherals, voltage regulators, and power management circuits, which are well known in the art, and therefore, will not be described any further.

The processing system 1414 may be coupled to a transceiver 1410. The transceiver 1410 is coupled to one or more antennas 1420. The transceiver 1410 provides a means for communicating with various other apparatus over a transmission medium. The processing system 1414 includes a processor 1404 coupled to a computer-readable medium 1406. The processor 1404 is responsible for general processing, including the execution of software stored on the computer-readable medium 1406. The software, when executed by the processor 1404, causes the processing system 1414 to perform the various functions described supra for any particular apparatus. The computer-readable medium 1406 may also be used for storing data that is manipulated by the processor 1404 when executing software. The processing system further includes at least one of the modules 1304, 1306. The modules may be software modules running in the processor 1404, resident/stored in the computer readable medium 1406, one or more hardware modules coupled to the processor 1404, or some combination thereof. The processing system 1414 may be a component of the UE 120 and may include the memory 682 and/or at least one of the TX Processor 664, the RX Processor 658, and the controller/processor 680.

In one configuration, the apparatus 1302/1302′ for wireless communication includes means for receiving a configuration for a carrier, and means for receiving MBMS information on the carrier on at least seven subframes of a radio frame. The apparatus may further include means for receiving at least one of SI, paging information, or synchronization information on the carrier. The apparatus may further include means for receiving unicast information or mixed unicast and MBMS information only on a subset of subframes of the radio frame. The aforementioned means may be one or more of the aforementioned modules of the apparatus 1302 and/or the processing system 1414 of the apparatus 1302′ configured to perform the functions recited by the aforementioned means. As described supra, the processing system 1414 may include the TX Processor 664, the RX Processor 658, and the controller/processor 680. As such, in one configuration, the aforementioned means may be the TX Processor 664, the RX Processor 658, and the controller/processor 680 configured to perform the functions recited by the aforementioned means.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill would further appreciate that the various illustrative logical blocks, modules, circuits, and algorithm steps described in connection with the disclosure herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

It is understood that the specific order or hierarchy of steps in the processes disclosed is an illustration of exemplary approaches. Based upon design preferences, it is understood that the specific order or hierarchy of steps in the processes may be rearranged. The accompanying method claims present elements of the various steps in a sample order, and are not meant to be limited to the specific order or hierarchy presented.

The various illustrative logical blocks, modules, and circuits described in connection with the disclosure herein may be implemented or performed with a general-purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the disclosure herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

In one or more exemplary designs, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein but is to be accorded the widest scope consistent with the principles and novel features disclosed herein.

What is claimed is:

1. A method of wireless communication, comprising:
receiving a configuration for an extension carrier; and
receiving multimedia broadcast multicast service (MBMS) information on the extension carrier on at least two subframes of a radio frame.

2. The method of claim 1, wherein the MBMS information on the extension carrier is received in at least seven subframes of the radio frame.

3. The method of claim 1, further comprising receiving a configuration for a base carrier before receiving the configuration for the extension carrier.

4. The method of claim 3, wherein the configuration for the extension carrier can only occur while configured for the base carrier.

5. The method of claim 3, wherein the MBMS information on the extension carrier is received in all subframes of the radio frame.

6. The method of claim 3, further comprising receiving at least one of system information, paging information, or synchronization information for the extension carrier only on the base carrier.

7. The method of claim 6, further comprising:
sending a request to a base station for system information for the extension carrier regarding MBMS provided by the base station on the extension carrier; and
receiving on the base carrier the system information for the extension carrier regarding MBMS provided by the base station on the extension carrier.

8. The method of claim 6, further comprising receiving from a base station system information for the extension carrier regarding MBMS provided by the base station on the extension carrier, the system information being broadcast with system information for the base carrier.

9. The method of claim 1, further comprising receiving unicast information or mixed unicast and MBMS information on a subset of subframes of the radio frame.

10. The method of claim 9, wherein the subset of subframes comprises subframe 0 and subframe 5, wherein the radio frame comprises ten subframes.

11. The method of claim 1, wherein the extension carrier is in a downlink band only and the downlink band does not have a corresponding uplink band.

12. A method of a wireless device, comprising:
receiving a configuration for a carrier; and
receiving multimedia broadcast multicast service (MBMS) information on the carrier on at least seven subframes of a radio frame.

13. The method of claim 12, wherein the wireless device is configured only with the carrier and no other carriers.

14. The method of claim 12, further comprising receiving at least one of system information, paging information, or synchronization information on the carrier.

15. The method of claim 12, further comprising receiving unicast information or mixed unicast and MBMS information only on a subset of subframes of the radio frame.

16. The method of claim 15, wherein the subset of subframes comprises subframe 0 and subframe 5, wherein the radio frame comprises ten subframes.

17. An apparatus for wireless communication, comprising:
means for receiving a configuration for an extension carrier; and
means for receiving multimedia broadcast multicast service (MBMS) information on the extension carrier on at least two subframes of a radio frame.

18. The apparatus of claim 17, wherein the MBMS information on the extension carrier is received in at least seven subframes of the radio frame.

19. The apparatus of claim 17, further comprising means for receiving a configuration for a base carrier before receiving the configuration for the extension carrier.

20. The apparatus of claim 19, wherein the configuration for the extension carrier can only occur while configured for the base carrier.

21. The apparatus of claim 19, wherein the MBMS information on the extension carrier is received in all subframes of the radio frame.

22. The apparatus of claim 19, further comprising means for receiving at least one of system information, paging information, or synchronization information for the extension carrier only on the base carrier.

23. The apparatus of claim 22, further comprising:
means for sending a request to a base station for system information for the extension carrier regarding MBMS provided by the base station on the extension carrier;
and means for receiving on the base carrier the system information for the extension carrier regarding MBMS provided by the base station on the extension carrier.

24. The apparatus of claim 22, further comprising means for receiving from a base station system information for the extension carrier regarding MBMS provided by the base station on the extension carrier, the system information being broadcast with system information for the base carrier.

25. The apparatus of claim 17, further comprising means for receiving unicast information or mixed unicast and MBMS information on a subset of subframes of the radio frame.

26. The apparatus of claim 25, wherein the subset of subframes comprises subframe 0 and subframe 5, wherein the radio frame comprises ten subframes.

27. The apparatus of claim 17, wherein the extension carrier is in a downlink band that has a corresponding paired uplink band.

28. An apparatus for wireless communication, comprising:
means for receiving a configuration for a carrier; and
means for receiving multimedia broadcast multicast service (MBMS) information on the carrier on at least seven subframes of a radio frame.

29. The apparatus of claim 28, wherein the apparatus is configured only with the carrier and no other carriers.

30. The apparatus of claim 28, further comprising means for receiving at least one of system information, paging information, or synchronization information on the carrier.

31. The apparatus of claim 28, further comprising means for receiving unicast information or mixed unicast and MBMS information only on a subset of subframes of the radio frame.

32. The apparatus of claim 31, wherein the subset of subframes comprises subframe 0 and subframe 5, wherein the radio frame comprises ten subframes.

33. An apparatus for wireless communication, comprising:
a processing system configured to:
receive a configuration for an extension carrier; and
receive multimedia broadcast multicast service (MBMS) information on the extension carrier on at least two subframes of a radio frame.

34. The apparatus of claim 33, wherein the MBMS information on the extension carrier is received in at least seven subframes of the radio frame.

35. The apparatus of claim 33, wherein the processing system is further configured to receive a configuration for a base carrier before receiving the configuration for the extension carrier.

36. The apparatus of claim 35, wherein the configuration for the extension carrier can only occur while configured for the base carrier.

37. The apparatus of claim 35, wherein the MBMS information on the extension carrier is received in all subframes of the radio frame.

38. The apparatus of claim 35, wherein the processing system is further configured to receive at least one of system information, paging information, or synchronization information for the extension carrier only on the base carrier.

39. The apparatus of claim 38, wherein the processing system is further configured to:
send a request to a base station for system information for the extension carrier regarding MBMS provided by the base station on the extension carrier; and
receive on the base carrier the system information for the extension carrier regarding MBMS provided by the base station on the extension carrier.

40. The apparatus of claim 38, wherein the processing system is further configured to receive from a base station system information for the extension carrier regarding MBMS provided by the base station on the extension carrier, the system information being broadcast with system information for the base carrier.

41. The apparatus of claim 33, wherein the processing system is further configured to receive unicast information or mixed unicast and MBMS information on a subset of subframes of the radio frame.

42. The apparatus of claim 41, wherein the subset of subframes comprises subframe 0 and subframe 5.

43. An apparatus for wireless communication, comprising:
a processing system configured to:
receive a configuration for a carrier; and
receive multimedia broadcast multicast service (MBMS) information on the carrier on at least seven subframes of a radio frame.

44. The apparatus of claim 43, wherein the apparatus is configured only with the carrier and no other carriers.

45. The apparatus of claim 43, wherein the processing system is further configured to receive at least one of system information, paging information, or synchronization information on the carrier.

46. The apparatus of claim 43, wherein the processing system is further configured to receive unicast information or mixed unicast and MBMS information only on a subset of subframes of the radio frame.

47. The apparatus of claim 46, wherein the subset of subframes comprises subframe 0 and subframe 5.

48. A computer program product comprising:
computer-readable medium comprising code for:
receiving a configuration for an extension carrier; and
receiving multimedia broadcast multicast service (MBMS) information on the extension carrier on at least two subframes of a radio frame.

49. A computer program product in a wireless device, comprising:
computer-readable medium comprising code for:
receiving a configuration for a carrier; and
receiving multimedia broadcast multicast service (MBMS) information on the carrier on at least seven subframes of a radio frame.
